(19) United States
(12) Patent Application Publication
(10) Pub. No.: US 2026/0236793 A1
(43) Pub. Date: Aug. 13, 2026

(54) SYSTEMS AND METHODS FOR MINING FREQUENTLY ASKED QUESTION (FAQ) FROM CONVERSATION DATA

(71) Applicant: GENESYS CLOUD SERVICES, INC., MENLO PARK, CA (US)

(72) Inventors: EMIR MUNOZ, GALWAY (IE); APOSTOLOS GALANOPOULOS, GALWAY (IE); PRASANTH BALARAMAN, GALWAY (IE); MANAN KALRA, GALWAY (IE)

(73) Assignee: GENESYS CLOUD SERVICES, INC., MENLO PARK, CA (US)

(21) Appl. No.: 19/049,678

(22) Filed: Feb. 10, 2025

(51) Int. Cl. G06N 5/022; G06F 16/2458

(52) U.S. Cl. CPC G06N 5/022; G06F 16/2465

(57) ABSTRACT

Systems and methods for mining question-and-answer pairs from conversation data to update knowledge bases are provided. In particular, a computing system may obtain conversation data, extract a question-and-answer pair from the conversation data with meta data using a machine learning model, the question-and-answer pair including a question and an answer corresponding to the question, determine whether a knowledge base includes existing content similar to the question-and-answer pair, provide the question-and-answer pair on a graphical user interface with an indication of a presence of any existing content in the knowledge base that is similar to the question-and-answer pair, receive an input to integrate the question-and-answer pair with the knowledge base, and update the knowledge base to integrate the question-and-answer pair in accordance with the input.

### BACKGROUND

Call centers and other contact centers are used by many organizations to provide technical and other support to their end users. The end user may interact with human and/or virtual agents of the contact center by establishing electronic communications via one or more communication technologies including, for example, telephone, email, web chat, Short Message Service (SMS), dedicated software application(s), and/or other technologies. Human and virtual agents alike leverage knowledge bases which may be created using organization frequently asked questions (FAQs) and knowledge articles (e.g., product documents, user manuals, and/or other relevant documentation), and follow various workflows when responding to end user inquiries.

To do so, chatbots have become ubiquitous tools for organizations and contact centers to deliver improved customer experiences and responsiveness to their customers. Given the rise of deep learning techniques, improved hardware, and artificial intelligence platforms, the development of chatbots has proliferated. For example, some chatbots may rely on knowledge bases and/or understand user intent and collect required information from a user to provide a suitable answer based on content in the knowledge bases. In other words, the content of the knowledge bases are an important aspect of contact centers and the reason for many interactions involving bots and human agents. However, the content may be very large and need continuous maintenance to ensure consistency and freshness of information to avoid risks, such as customers receiving outdated information.

It is with respect to these and other general considerations that embodiments have been described. Also, although relatively specific problems have been discussed, it should be understood that the embodiments should not be limited to solving the specific problems identified in the background.

### SUMMARY

In accordance with an embodiment of the present disclosure, a frequency asked question (FAQ) mining is performed to extract question-and-answer pairs from conversation data between contact center agents and customers and enrich pre-existing knowledge bases. It should be appreciated that the question-and-answer pairs are also referred to as frequency asked questions (FAQs) throughout the present disclosure. For example, the conversation data is structured as turn-by-turn utterances (e.g., voice or text) between contact center agents and customers via call, chat, message, and/or email. Exemplary conversation data includes transcripts, chat logs, message logs, and/or email threads of conversations between contact center agents and customers. The mined FAQs are then compared against a pre-existing knowledge base to determine whether the mined FAQs or similar thereof already exist in the pre-existing knowledge base. The knowledge base stores content to support collecting, organizing, retrieving, and sharing knowledge. It should be appreciated that the content may be any set of knowledge articles (e.g., product documents, user manuals, workforce management documents, and/or other relevant documentation) or FAQs consistent with the other features described herein. For example, the knowledge base is utilized to provide relevant FAQ answers when questions are asked by end users through various touchpoints. The touchpoints may include a digital chat bot for end-users, an agent assist platform for contact center agents, or a customer's website for end users. For example, each FAQ in the knowledge base may include a question, an answer or multiple variations of answers for different touchpoints, and optional alternative questions to improve search. Based on whether the mined FAQ exists in the pre-existing knowledge base, the mined FAQ may be merged with existing content in the pre-existing knowledge base or be added to the pre-existing knowledge base as new content.

In accordance with at least one example of the present disclosure, a method for mining question-and-answer pairs from conversation data to update knowledge bases is provided. The method may include obtaining conversation data, extracting a question-and-answer pair from the conversation data with meta data using a machine learning model, the question-and-answer pair including a question and an answer corresponding to the question, determining whether a knowledge base includes any existing content similar to the question-and-answer pair, providing the question-and-answer pair on a graphical user interface with an indication of a presence of any existing content in the knowledge base that is similar to the question-and-answer pair, receiving an input to integrate the question-and-answer pair with the knowledge base, and updating the knowledge base to integrate the question-and-answer pair in accordance with the input.

In accordance with at least one example of the present disclosure, a computing system for mining question-and-answer pairs from conversation data to update knowledge bases is provided. The computing system may include at least one processor and at least one memory comprising a plurality of instructions stored therein that, in response to execution by the at least one processor, causes the computing system to obtain conversation data, extract a question-and-answer pair from the conversation data with meta data using a machine learning model, the question-and-answer pair including a question and an answer corresponding to the question, determine whether a knowledge base includes existing content similar to the question-and-answer pair, provide the question-and-answer pair on a graphical user interface with an indication of a presence of any existing content in the knowledge base that is similar to the question-and-answer pair, receive an input to integrate the question-and-answer pair with the knowledge base, and update the knowledge base to integrate the question-and-answer pair in accordance with the input.

Any of the one or more above aspects in combination with any other of the one or more aspects. Any of the one or more aspects as described herein.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 is a simplified schematic diagram of a frequently asked question (FAQ) mining pipeline in accordance with an embodiment of the present disclosure;

FIG. 4 is an exemplary schematic diagram illustrating how a question-and-answer pair is extracted from conversation data in accordance with an embodiment of the present disclosure;

FIG. 5 is an exemplary user interface of a computing device illustrating how conversation data is obtained in accordance with an embodiment of the present disclosure;

FIGS. 6A and 6B are exemplary diagrams illustrating a deduplication process of question-and-answer pairs in accordance with an embodiment of the present disclosure; and FIGS. 7A and 7B are an exemplary method of FAQ mining in accordance with an embodiment of the present disclosure.

### DETAILED DESCRIPTION

For the purpose of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art. Particular features, structures or characteristics may be combined in any suitable combinations and/or sub-combinations in one or more embodiments or examples. Those skilled in the art will recognize that various embodiments may be computer implemented using many different types of data processing equipment, with embodiments being implemented as an apparatus, method, or computer program product. Example embodiments, thus, may take the form of a hardware embodiment, a software embodiment, or combination thereof.

### Computing Device

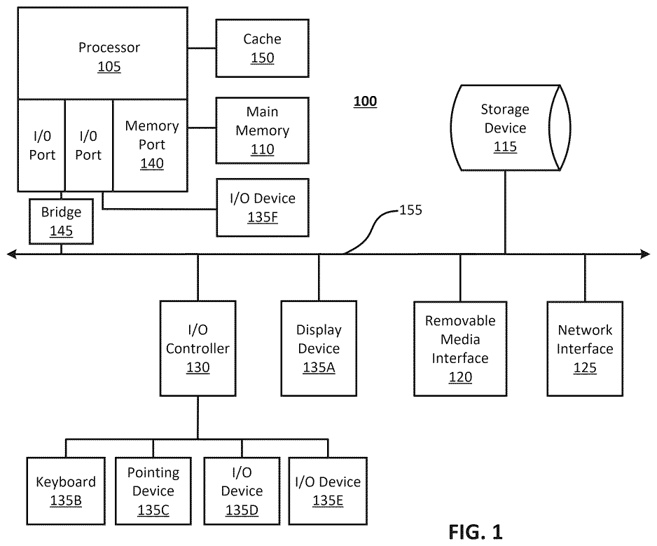

The present invention may be computer implemented using different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced.

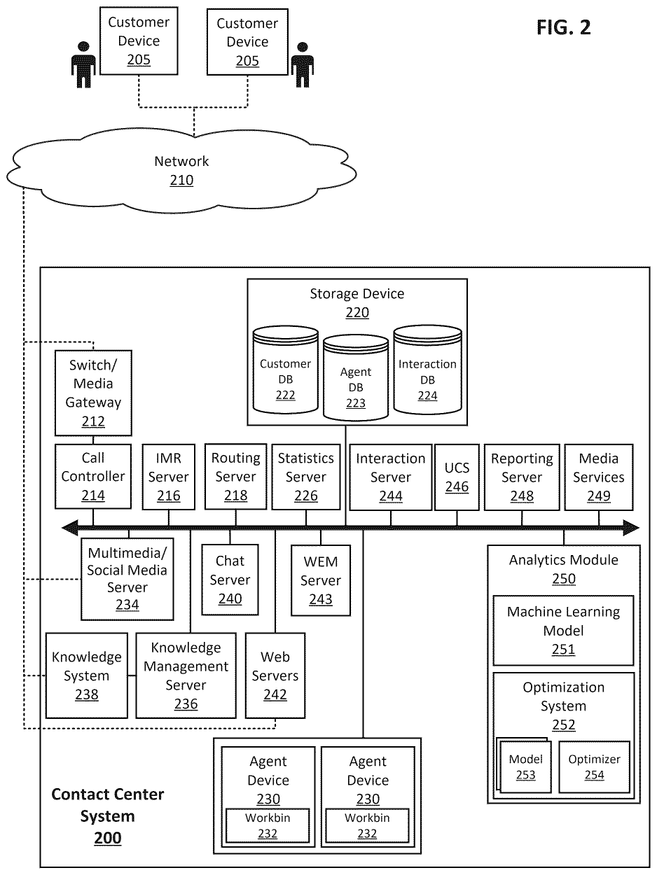

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (Saas) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the processor 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The main memory 110 may be one or more memory chips capable of storing data and allowing stored data to be accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. More generally, the I/O devices 135 may include any conventional devices for performing the functionality described herein.

Unless otherwise limited, the computing device 100 may be any workstation, desktop computer, laptop or notebook computer, server machine, virtualized machine, mobile or smart phone, portable telecommunication device, media playing device, or any other type of computing, telecommunications or media device, without limitation, capable of performing the operations and functionality described herein. The computing device 100 may include a plurality of such devices connected by a network or connected to other systems and resources via a network. Unless otherwise limited, the computing device 100 may communicate with other computing devices 100 via any type of network using any conventional communication protocol.

### Contact Center

With reference now to FIG. 2, a communications infrastructure or contact center system (or simply “contact center”) 200 is shown in accordance with exemplary embodiments of the present invention and/or with which exemplary embodiments of the present invention may be enabled or practiced. By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between agents and customers may be conducted over a variety of communication channels, such as, for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as interactive voice response (IVR) systems, interactive media response (IMR) systems, internet robots or “bots”, automated chat modules or “chatbots”, and the like.

Referring specifically to FIG. 2, the contact center 200 may be used by a customer service provider to provide various types of services to customers. For example, the contact center 200 may be used to engage and manage interactions in which automated processes (or bots) or human agents communicate with customers. The contact center 200 may be an in-house facility of a business or enterprise for performing the functions of sales and customer service relative to products and services available through the enterprise. In another aspect, the contact center 200 may be operated by a service provider that contracts to provide customer relation services to a business or organization. Further, the contact center 200 may be deployed on equipment dedicated to the enterprise or third-party service provider, and/or deployed in a remote computing environment such as, for example, a private or public cloud environment with infrastructure for supporting multiple contact centers for multiple enterprises. The contact center 200 may include software applications or programs, which may be executed on premises or remotely or some combination thereof. It should further be appreciated that the various components of the contact center 200 may be distributed across various geographic locations.

Unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center 200 may include: a plurality of customer devices 205; communications network (or simply “network”) 210; switch/media gateway 212; call controller 214; interactive media response (IMR) server 216; routing server 218; storage device 220; statistics server 226; plurality of agent devices 230 that each have a workbin 232; multimedia/social media server 234; knowledge management server 236 coupled to a knowledge system 238; chat server 240; web servers 242; interaction server 244; universal contact server (or “UCS”) 246; reporting server 248; media services server 249; and an analytics module 250. It should be understood that any of the computer-implemented components, modules, or servers described in relation to FIG. 2 or in any of the following figures may be implemented via computing devices, such as the computing device 100 of FIG. 1. As will be seen, the contact center 200 generally manages resources (e.g., personnel, computers, telecommunication equipment, etc.) to enable the delivery of services via telephone, email, chat, or other communication mechanisms. The various components, modules, and/or servers of FIG. 2 (and other figures included herein) each may include one or more processors executing computer program instructions and interacting with other system components for performing the various functionalities described herein. Further, the terms “interaction” and “communication” are used interchangeably, and generally refer to any real-time and non-real-time interaction that uses any communication channel including, without limitation, telephone calls (PSTN or VoIP calls), emails, voicemails, video, chat, screen-sharing, text messages, social media messages, WebRTC calls, etc. Access to and control of the components of the contact system 200 may be affected through user interfaces (UIs) which may be generated on the customer devices 205 and/or the agent devices 230.

Customers desiring to receive services from the contact center 200 may initiate inbound communications (e.g., telephone calls, emails, chats, etc.) to the contact center 200 via a customer device 205. While FIG. 2 shows two such customer devices it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center 200, such as telephone calls, emails, chats, text messages, web-browsing sessions, and other multi-media transactions. Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access network, global system for mobile communications (GSM) network, or any wireless network/technology conventional in the art.

The switch/media gateway 212 may be coupled to the network 210 for receiving and transmitting telephone calls between customers and the contact center 200. The switch/media gateway 212 may include a telephone or communication switch configured to function as a central switch for agent routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. In general, the switch/media gateway 212 establishes a voice connection between the customer and the agent by establishing a connection between the customer device 205 and agent device 230. The switch/media gateway 212 may be coupled to the call controller 214 which, for example, serves as an adapter or interface between the switch and the other routing, monitoring, and communication-handling components of the contact center 200. The call controller 214 may be configured to process PSTN calls, VoIP calls, etc. The call controller 214 may include computer-telephone integration (CTI) software for interfacing with the switch/media gateway and other components. The call controller 214 may extract data about an incoming interaction, such as the customer's telephone number, IP address, or email address, and then communicate these with other contact center components in processing the interaction.

The interactive media response (IMR) server 216 enables self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. Through continued interaction with the IMR server 216, customers may receive service without needing to speak with an agent. The IMR server 216 may ascertain why a customer is contacting the contact center so to route the communication to the appropriate resource.

The routing server 218 routes incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230, which may enhance the service the agent is able to provide.

Regarding data storage, the contact center 200 may include one or more mass storage devices—represented generally by the storage device 220—for storing data in one or more databases. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center 200 may include agent availability and agent profiles, schedules, skills, average handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center 200 in ways that facilitate the functionality described herein. For example, the servers or modules of the contact center 200 may query such databases to retrieve data stored therewithin or transmit data thereto for storage.

The statistics server 226 may be configured to record and aggregate data relating to the performance and operational aspects of the contact center 200. Such information may be compiled by the statistics server 226 and made available to other servers and modules, such as the reporting server 248, which then may produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center 200 to facilitate the functionality described herein. An agent device 230, for example, may include a telephone adapted for regular telephone calls or VoIP calls. An agent device 230 may further include a computing device configured to communicate with the servers of the contact center 200, perform data processing associated with operations, and interface with customers via voice, chat, email, and other multimedia communication mechanisms according to functionality described herein. While only two such agent devices are shown, any number may be present.

The multimedia/social media server 234 may be configured to facilitate media interactions (other than voice) with the customer devices 205 and/or the servers 242. Such media interactions may be related, for example, to email, voicemail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management server 234 may be configured to facilitate interactions between customers and the knowledge system 238. In general, the knowledge system 238 may be a computer system capable of receiving questions or queries and providing answers in response. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art.

The chat server 240 may be configured to conduct, orchestrate, and manage electronic chat communications with customers. Such chat communications may be conducted by the chat server 240 in such a way that a customer communicates with automated chatbots, human agents, or both. The chat server 240 may perform as a chat orchestration server that dispatches chat conversations among chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature. The chat server 240 may be configured to transfer chats within a single chat session with a particular customer between automated and human sources. The chat server 240 may be coupled to the knowledge management server 234 and the knowledge systems 238 for receiving suggestions and answers to queries posed by customers during a chat so that, for example, links to relevant articles can be provided.

The web servers 242 provide site hosts for a variety of social interaction sites to which customers subscribe, such as Facebook, Twitter, Instagram, etc. Though depicted as part of the contact center 200, it should be understood that the web servers 242 may be provided by third parties and/or maintained remotely. The web servers 242 may also provide webpages for the enterprise or organization being supported by the contact center 200. For example, customers may browse the webpages and receive information about the products and services of a particular enterprise. Within such enterprise webpages, mechanisms may be provided for initiating an interaction with the contact center 200, for example, via web chat, voice, or email. An example of such a mechanism is a widget, which can be deployed on the webpages or websites hosted on the web servers 242. As used herein, a widget refers to a user interface component that performs a particular function. In some implementations, a widget includes a GUI that is overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Such widgets may include additional user interfaces and be configured to access a variety of local resources (e.g., a calendar or contact information on the customer device) or remote resources via network (e.g., instant messaging, electronic mail, or social networking updates).

The interaction server 244 is configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

The universal contact server (UCS) 246 may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer, such as data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to a request and used toward managing the contact center in accordance with functionality described herein.

The media services server 249 provides audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, audio and video transcoding, secure real-time transport protocol (SRTP), audio or video conferencing, call analysis, keyword spotting, etc.

The analytics module 250 may be configured to perform analytics on data received from a plurality of different data sources as functionality described herein may require. The analytics module 250 may also generate, update, train, and modify predictors or models, such as machine learning model 251 and/or models 253, based on collected data. To achieve this, the analytics module 250 may have access to the data stored in the storage device 220, including the customer database 222 and agent database 223. The analytics module 250 also may have access to the interaction database 224, which stores data related to interactions and interaction content (e.g., audio and transcripts of the interactions and events detected therein), interaction metadata (e.g., customer identifier, agent identifier, medium of interaction, length of interaction, interaction start and end time, department, tagged categories), and the application setting (e.g., the interaction path through the contact center). The analytic module 250 may retrieve such data from the storage device 220 for developing and training algorithms and models. It should be understood that, while the analytics module 250 is depicted as being part of a contact center, the functionality described in relation thereto may also be implemented on customer systems (or, as also used herein, on the “customer-side” of the interaction) and used for the benefit of customers.

The machine learning model 251 may include one or more artificial intelligence-based models, including machine learning models, such as neural networks, deep learning models as well as other types as described herein. As an example, the machine learning model 251 may be configured to predict behavior. Such behavioral models may be trained to predict the behavior of customers and agents in a variety of situations so that interactions may be personally tailored to customers and handled more efficiently by agents. As another example, the machine learning model 251 may be configured to predict aspects related to contact center operation and performance. In other cases, for example, the machine learning model 251 also may be configured to perform natural language processing and, for example, provide intent recognition and the like.

The analytics module 250 may further include an optimization system 252. The optimization system 252 may include one or more models 253, which may include the machine learning model 251, and an optimizer 254. The optimizer 254 may be used in conjunction with the models 253 to minimize a cost function subject to a set of constraints, where the cost function is a mathematical representation of desired objectives or system operation. Because the models 253 are typically non-linear, the optimizer 254 may be a nonlinear programming optimizer. It is contemplated, however, that the optimizer 254 may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The analytics module 250 may utilize the optimization system 252 as part of an optimization process by which aspects of contact center performance and operation are optimized or, at least, enhanced. This, for example, may include aspects related to the customer experience, agent experience, interaction routing, natural language processing, intent recognition, allocation of system resources, system analytics, or other functionality related to automated processes.

### FAQ Mining

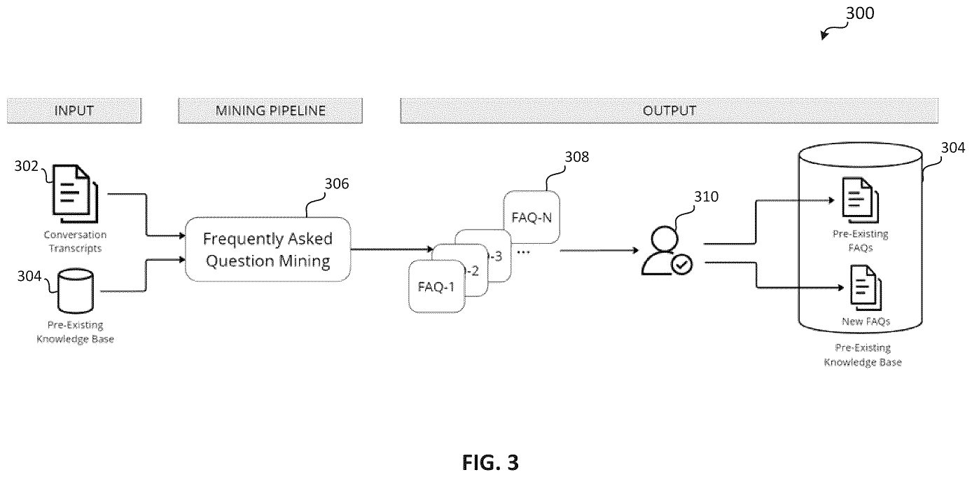

Turning now to FIGS. 3-7, the functionality of methods and systems related to frequently asked question (FAQ) mining will be described.

Referring to FIG. 3, a simplified diagram 300 illustrating a frequency asked question (FAQ) mining pipeline for extracting question-and-answer pairs from conversation data to enrich pre-existing knowledge bases is shown. As shown, a computing system (e.g., the computing device 100, the contact center system 200, and/or other computing devices described herein) performs FAQ mining 306 on a set of the conversation data (e.g., conversation transcripts 302 of conversations) between contact center agents and customers to identify and extract question-answer pairs out of customer-agent interaction transcripts 302. For example, the conversation data is structured as turn-by-turn utterances (e.g., voice or text) between contact center agents and customers via call, chat, message, and/or email. Exemplary conversation data includes transcripts, chat logs, message logs, and/or email threads of conversations between contact center agents and customers.

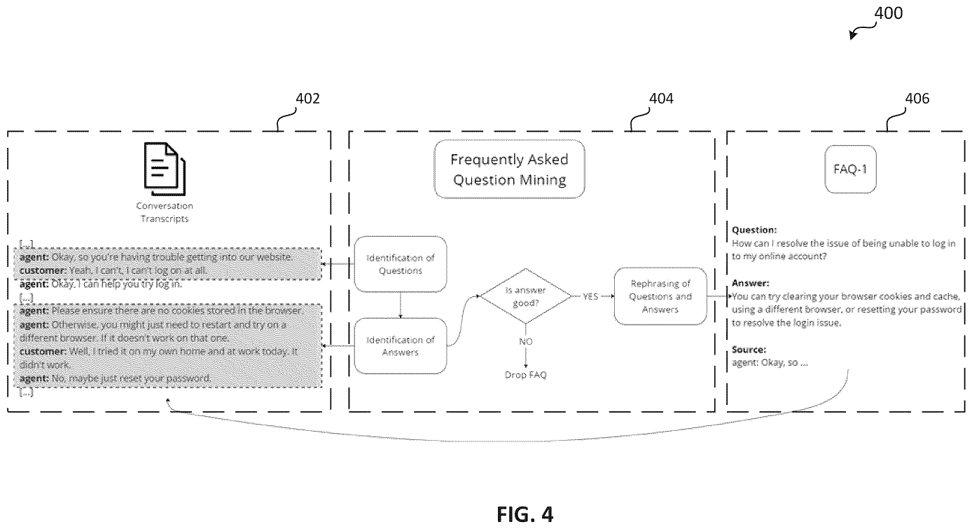

For example, the exemplary block diagram 400 of FIG. 4 illustrates how the mined question-and-answer pairs are extracted from conversation data. As illustrated in FIG. 4, conversation data or transcripts 402 include turn-by-turn utterances between a contact center agent and a customer. Once the conversation transcripts 402 are inputted to the computing system, the computing system performs FAQ mining 404 by analyzing the conversation transcript 402 to identify any questions. Subsequently, for each identified question, the computing system identifies a corresponding answer and determines whether the answer satisfies a predetermined quality requirement to ensure the quality of mined FAQs. For example, the answer may satisfy the predetermined quality requirement if the answer was provided by an agent who satisfy predetermined criteria (e.g., exceeding a predetermined experience level and/or exceeding a predetermined performance score of the agent). If the answer does not satisfy the predetermined quality requirement, the corresponding question-and-answer pair is excluded from further consideration. If, however, the answer satisfies the predetermined quality requirement, the corresponding question-and-answer pair 406 is stored with metadata (e.g., a source of the question-and-answer pair, frequency with which the corresponding question appears in the conversation transcripts) for further review.

Referring back to FIG. 3, the computing system further determines which pre-existing knowledge base 304 to use for the FAQ mining process. For example, the computing system may receive an input from a user indicating which knowledge base to use for the FAQ mining process. As described above, the knowledge base 304 stores content to support collecting, organizing, retrieving, and sharing knowledge. It should be appreciated that the content may be any set of knowledge articles (e.g., product documents, user manuals, workforce management documents, and/or other relevant documentation) or FAQs consistent with the other features described herein. For example, the knowledge base 304 is utilized to provide relevant FAQ answers when questions are asked by end users through various touchpoints. The touchpoints may include a digital chat bot for end-users, an agent assist platform for contact center agents, or a customer's website for end users. For example, each FAQ in the knowledge base 304 includes a question, an answer or multiple variations of answers for different touchpoints, and optional alternative questions to improve search.

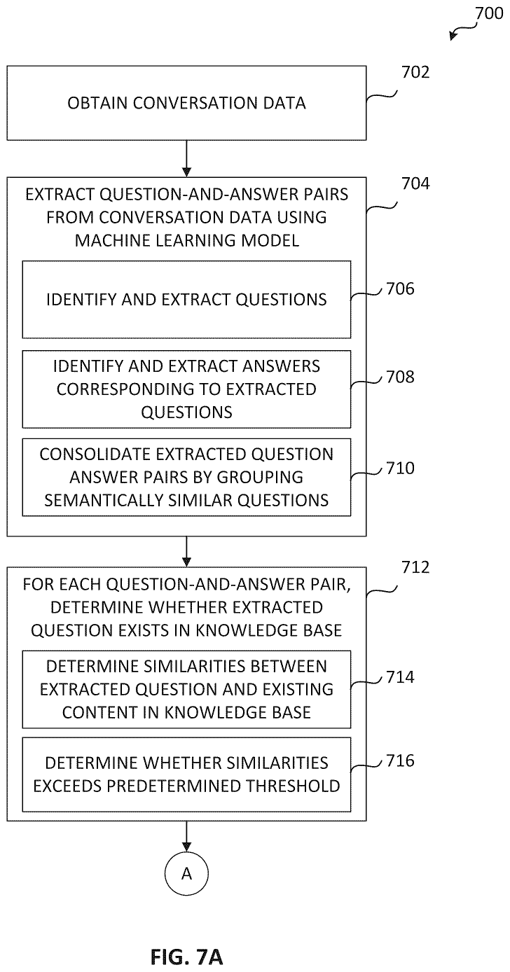

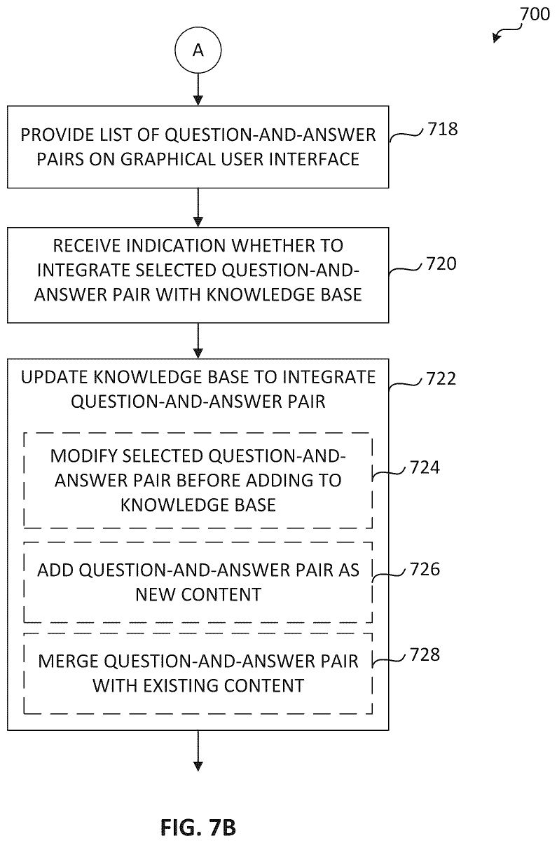

Once the question-and-answer pairs 308 (e.g., FAQ-1, . . . , FAQ-N) are extracted from the conversation data, the computing system determines whether the extracted question-answer pairs exist in the pre-existing knowledge base 304. This is also referred to as a deduplication process of the FAQ mining pipeline. To do so, in some embodiments, the computing system determines similarities between the extracted question and existing content in the knowledge base 304. In such embodiments, the computing system exports the existing content from the knowledge base 304, computes embeddings for questions and alternative questions extracted from the existing content, and indexes the embeddings in a vector database. The computing system then embeds the extracted question from the conversation data to find matches with indexed questions from the knowledge base 304 and determines whether the similarities exceed a predetermined similarity threshold. Exemplary diagrams of FIGS. 6A and 6B illustrate the deduplication process. Specifically, mined question-and-answer pairs FAQ-1 of FIG. 6A and FAQ-2 of FIG. 6B are compared with existing content in the knowledge base for similarity, resulting in either merged FAQ for highly similar FAQ-1 (FIG. 6A) or separate FAQ-2 for distinct question (FIG. 6B).

Alternatively, in other embodiments, the computing system may utilize a knowledge search service (KSS) to determine whether the extracted question of each question-and-answer pair exists in the knowledge base 304. KSS has an endpoint to search the knowledge base 304 with a query to find an answer for that query if the semantically similar FAQ or knowledge article exists in the knowledge base 304. The search result also includes confidence scores. Using the KSS search endpoint, the computing system may send the extracted question as a query to the knowledge base 304 and determine if the extracted question already exists as a FAQ or a knowledge article in the knowledge base 304 based on the confidence scores in the search response. It should be appreciated that any method of measuring similarities in data may be utilized to determine whether the extracted questions or similar thereof are already part of the existing knowledge base 304.

Subsequently, a list of extracted or mined question-and-answer pairs is provided to a reviewer 310 for review. In some embodiments, questions from the mined question-and-answer pairs are presented to the reviewer 310 in order of the frequency with which each respective question appears in the conversation data. As described above, when each question-and-answer pair is extracted from the conversation data, the respective frequency is also stored as metadata. When the reviewer 310 selects a question from the list of questions, more detailed information is provided to the reviewer 310. For example, the detailed information may include the question, the corresponding answer to the question, any similar content in the knowledge base 304, and suggested phrasings of the question. The suggested phrasings are alternative variations of the question that may be associated with the corresponding question-and-answer pair to improve searchability for end users downstream. It should be appreciated that the detailed information may be presented in a panel separate from the panel showing the list of mined question-and-answer pairs. Those two panels may be presented in the same display window or two different display windows on a graphical user interface (GUI).

Additionally, for each question-and-answer pair, the computing system provides an option for the reviewer 310 to choose how to import the corresponding question-and-answer pair and integrate with the knowledge base 304. For example, the computing system provides an option to import the corresponding question-and-answer pair as new content. If the computing system determines that similar content already exists in the knowledge base 304, the computing system further provides an option to merge the corresponding question-and-answer pair with the existing content.

Based on an input received from the reviewer 310, the computing system integrates the question-and-answer pair selected from the list of question-and-answer pairs with the knowledge base 304 accordingly to ensure that the knowledge base 304 is both updated with fresh information and maintains consistency with existing content.

Referring now to FIGS. 7A and 7B, an exemplary frequency asked question (FAQ) mining process or method 700 is shown in accordance with aspects of the present disclosure. More specifically, in use, a computing system (e.g., the computing device 100, the contact center system 200, and/or other computing devices described herein) may execute a method 700 for mining FAQs from conversation data using a machine learning model. For example, the machine learning model may be a generative artificial intelligence (AI) model, such as a large language model (LLM). It should be appreciated that the particular blocks of the method 700 are illustrated by way of example, and such blocks may be combined or divided, added or removed, and/or reordered in whole or in part depending on the particular embodiment, unless stated to the contrary.

The method 700 begins with block 702 in which the computing system obtains conversation data. As described above, the computing system performs a task of mining question-and-answer pairs or FAQs from conversation data using a machine learning model to enrich a pre-existing knowledge base. For example, the conversation data is structured as turn-by-turn utterances (e.g., voice or text) between contact center agents and customers via call, chat, message, and/or email. Exemplary conversation data includes transcripts, chat logs, message logs, and/or email threads of conversations between contact center agents and customers. Additionally, the conversation data may be retrieved using application programming interfaces (APIs) in the computing system. It should be appreciated that, in some embodiments, the conversation data may be retrieved using a generative AI to generate a query (e.g., structured query language (SQL) query) or an API call based on API documentation in the computing system.

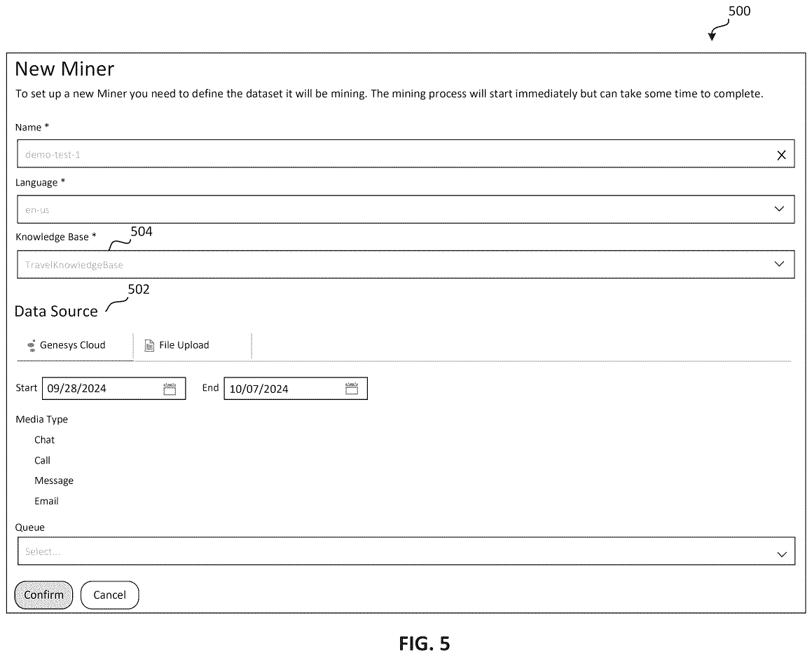

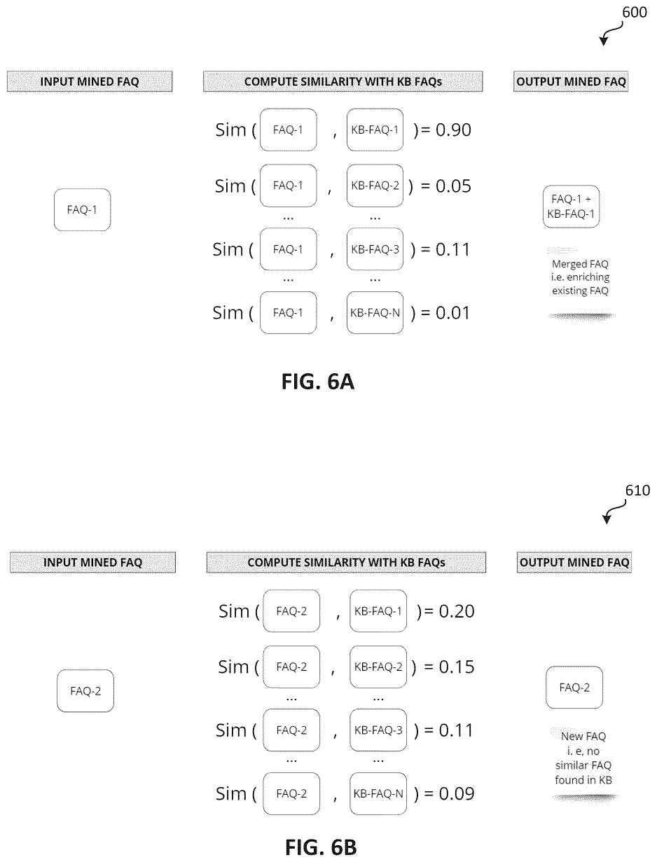

In some embodiments, the computing system may fetch conversation data between contact center agents and customers. For example, as shown in FIG. 5, a user may request the computing system to create a job for mining FAQs from conversation data. To do so, the user may select a data source 502 of the conversation data. For example, the user may define a data range (e.g., a date range) and a media type (e.g., call, chat, message, and/or email) of the conversation data to be fetched from a data storage (e.g., a storage device 220 of the contact center system 200). The user may further request to fetch the conversation data from a specific queue. It should be appreciated that, when fetching the conversation data, the computing system may be configured to focus on high-quality conversations to ensure the quality of mined FAQs. For example, the high-quality conversations include conversations between customers and agents, who satisfy predetermined criteria (e.g., exceeding a predetermined experience level and/or exceeding a predetermined performance score). Alternatively, in other embodiments, a user may upload one or more files that contain conversation data to the computing system.

In block 704, the computing system extracts question-and-answer pairs from the conversation data using a machine learning model (e.g., a large language model, a small language model). To do so, in block 706, the computing system analyzes the conversation data to identify and extract questions from the conversation data. In block 708, the computing system identifies and extracts corresponding answers to the extracted questions. Subsequently, in block 710, the computing system consolidates the extracted question-and-answer pairs by grouping semantically similar questions using a machine learning model. For example, the same question may appear in multiple conversations in the conversation data, but it may be phrased differently. By grouping semantically similar questions, the computing system consolidates variations of the same question into a single, representative question. For example, the extracted questions and answers are transformed into vector representations using text embeddings, which are then grouped into clusters using a data clustering algorithm (e.g., density-based spatial clustering of applications with noise (DBSCAN) or hierarchical density-based spatial clustering of applications with noise (HDBSCAN)).

In block 712, for each question-and-answer pair, the computing system determines whether the extracted question of the corresponding question-and-answer pair exists in a knowledge base. In the illustrative embodiment, the computing system receives an indication of a knowledge base to be used for the FAQ mining process. For example, as shown in FIG. 5, a user may select a knowledge base 504 when creating a new job request. The knowledge base is a database that stores knowledge articles (e.g., product documents, user manuals, and/or other relevant documentation) and/or FAQs to support collecting, organizing, retrieving, and sharing knowledge. For example, the knowledge base is utilized to provide relevant FAQ answers when questions are asked by end users through various touchpoints. The touchpoints may include a digital chat bot for end-users, an agent assist platform for contact center agents, or a customer's website for end users. For example, each FAQ in the knowledge base includes a question, an answer or multiple variations of answers for different touchpoints, and optional alternative questions to improve search.

To do so, in block 714, the computing system determines similarities between the extracted question and existing content in the knowledge base. To do so, the computing system exports the existing content from the knowledge base, computes embeddings for questions and alternative questions extracted from the existing content, and indexes the embeddings in a vector database. The computing system then embeds the extracted question from the conversation data to find matches with indexed questions from the knowledge base. Subsequently, in block 716, the computing system determines whether the similarities exceed a predetermined similarity threshold. As described further below, the computing system determines whether the extracted question is already part of the knowledge base or is a new FAQ based on the predetermined similarity threshold. For example, the exemplary diagrams of FIGS. 6A and 6B illustrate how the mined question-and-answer pairs (i.e., “FAQ-1” in FIG. 6A and “FAQ-2” in FIG. 6B) are compared for similarity, resulting in either merged FAQ for highly similar FAQ-1 (FIG. 6A) or separate FAQ-2 for distinct question (FIG. 6B).

In other embodiments, the computing system may utilize a knowledge search service (KSS) to determine whether the extracted question of each question-and-answer pair exists in the knowledge base. KSS has an endpoint to search a knowledge base with a query to find an answer for that query if the semantically similar FAQ or knowledge article exists in the knowledge base. The search result also includes confidence scores. Using the KSS search endpoint, the computing system may send the extracted question as a query to the knowledge base and determine if the extracted question already exists as a FAQ or a knowledge article in the knowledge base based on the confidence scores in the search response.

Subsequently, in block 718 of FIG. 7B, the computing system provides a list of mined question-and-answer pairs on a graphical user interface (GUI). More specifically, a list of questions from the mined question-and-answer pairs is presented to a user in order of the frequency with which each respective question appears in the conversation data. As described above, when each question-and-answer pair is extracted from the conversation data, the respective frequency is also stored as metadata. When the user selects a question from the list of questions, more detailed information is provided to the user. For example, the detailed information may include the question, the corresponding answer to the question, any similar content in the knowledge base, and suggested phrasings of the question. The suggested phrasings are alternative variations of the question that may be associated with the corresponding question-and-answer pair to improve searchability for end users downstream. It should be appreciated that the detailed information may be presented in a panel separate from the panel showing the list of mined question-and-answer pairs. Those two panels may be presented in the same display window or two different display windows on a graphical user interface (GUI).

Additionally, for each question-and-answer pair, the computing system provides an option for the user to choose how to import the corresponding question-and-answer pair and integrate with the knowledge base. For example, the computing system provides an option to import the corresponding question-and-answer pair as new content. If the computing system determines that similar content already exists in the knowledge base, the computing system further provides an option to merge the corresponding question-and-answer pair with the existing content. Accordingly, in block 720, the computing system receives an indication whether to integrate a selected question-and-answer pair selected from the list of question-and-answer pairs with the knowledge base.

Subsequently, in block 722, the computing system updates the knowledge base to integrate the mined question-and-answer pair in response to receiving the indication. In some embodiments, the computing system may modify the detailed information associated with the mined question-and-answer pair based on user feedback prior to adding the mined question-and-answer pair to the knowledge base, as indicated in block 724. For example, the computing system may receive edits to the mined question-and-answer pair from the user. In some embodiments, some edits may be performed by the computing system using a generative artificial intelligence (AI) model, such as a large language model (LLM).

In some embodiments, if the computing system determines that the indication represents a selection of the option to import the corresponding question-and-answer pair as new content, the computing system proceeds to add the corresponding question-and-answer pair with the knowledge base as new content, as indicated in block 726. Alternatively, in certain embodiments, if the computing system determines that the indication represents a selection of the option to merge the corresponding question-and-answer pair with the existing content, the computing system proceeds to add the corresponding question-and-answer pair with the knowledge base by merging the corresponding question-and-answer pair with the existing content, as indicated in block 728. In such embodiments, the computing system may utilize the pre-existing answer from the knowledge base as a foundation and enrich the pre-existing answer with the new extracted answer from the conversation data. This ensures that the knowledge base is both updated with fresh information and maintains consistency with existing content.

Although the blocks 702-728 are described in a relatively serial manner, it should be appreciated that various blocks of the method 700 may be performed in parallel in some embodiments.

As one of skill in the art will appreciate, the many varying features and configurations described above in relation to the several exemplary embodiments may be further selectively applied to form the other possible embodiments of the present disclosure. For the sake of brevity and taking into account the abilities of one of ordinary skill in the art, each of the possible iterations is not provided or discussed in detail, though all combinations and possible embodiments embraced by the several claims below or otherwise are intended to be part of the instant application. Further, it should be apparent that the foregoing relates only to the described embodiments of the present application and that numerous changes and modifications may be made herein without departing from the spirit and scope of the present application as defined by the following claims and the equivalents thereof.

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In accordance with at least one example of the present disclosure, a method for mining question-and-answer pairs from conversation data to update knowledge bases is provided. The method may include obtaining conversation data, extracting a question-and-answer pair from the conversation data with meta data using a machine learning model, the question-and-answer pair including a question and an answer corresponding to the question, determining whether a knowledge base includes any existing content similar to the question-and-answer pair, providing the question-and-answer pair on a graphical user interface with an indication of a presence of any existing content in the knowledge base that is similar to the question-and-answer pair, receiving an input to integrate the question-and-answer pair with the knowledge base, and updating the knowledge base to integrate the question-and-answer pair in accordance with the input.

In accordance with at least one aspect of the above method, the method may include where the conversation data includes one or more chat messages, one or more voice transcripts, and/or one or more emails.

In accordance with at least one aspect of the above method, the method may include where providing the question-and-answer pair on the graphical user interface comprises in response to determining that the knowledge base does not include any existing content similar to the question-and-answer pair, providing the question-and-answer pair and an option to create new content to add the question-and-answer pair to the knowledge base.

In accordance with at least one aspect of the above method, the method may include where providing the question-and-answer pair on the graphical user interface comprises in response to determining that the knowledge base includes the existing content similar to the question-and-answer pair, providing the question-and-answer pair, a question or a title of the existing content, a first option to merge the question-and-answer pair with the existing content, and a second option to create new content to add the question-and-answer pair to the knowledge base.

In accordance with at least one aspect of the above method, the method may include where providing the question answer pair on the graphical user interface includes providing one or more alternative phrasings of the question selectable as alternative questions to the question of the question-and-answer pair.

In accordance with at least one aspect of the above method, the method may include where the input indicates how to integrate the question-and-answer pair with the knowledge base.

In accordance with at least one aspect of the above method, the method may include where extracting a question-and-answer pair from the conversation data with the meta data using the machine learning model comprises consolidating one or more question-and-answer pairs from the conversation data by grouping semantically similar questions among the one or more question-and-answer pairs.

In accordance with at least one aspect of the above method, the method may include where determining whether the knowledge base includes any existing content similar to the question-and-answer pair comprises comparing the question of the question-answer-pair and existing content in the knowledge base to determine a similarity score between the question and the existing content, determining whether the similarity score exceed a predetermined threshold, and if the similarity score exceeds the predetermined threshold, determining that the knowledge base includes the existing content similar to the question-and-answer pair.

In accordance with at least one aspect of the above method, the method may include where the existing content is one or more existing articles and/or one or more existing frequently asked questions (FAQs) in the knowledge base.

In accordance with at least one aspect of the above method, the method may include where the meta data includes a frequency of the question in the conversation data and one or more sources of the question within the conversation data where the question was extracted.

In accordance with at least one aspect of the above method, the method may include where updating the knowledge base to integrate the question-and-answer pair in accordance with the input comprises receiving a modification to the question-and-answer pair to modify the question-and-answer pair and updating the knowledge base to integrate the modified question-and-answer with the knowledge base.

In accordance with at least one example of the present disclosure, a computing system for mining question-and-answer pairs from conversation data to update knowledge bases is provided. The computing system may include at least one processor and at least one memory comprising a plurality of instructions stored therein that, in response to execution by the at least one processor, causes the computing system to obtain conversation data, extract a question-and-answer pair from the conversation data with meta data using a machine learning model, the question-and-answer pair including a question and an answer corresponding to the question, determine whether a knowledge base includes existing content similar to the question-and-answer pair, provide the question-and-answer pair on a graphical user interface with an indication of a presence of any existing content in the knowledge base that is similar to the question-and-answer pair, receive an input to integrate the question-and-answer pair with the knowledge base, and update the knowledge base to integrate the question-and-answer pair in accordance with the input.

In accordance with at least one aspect of the above computing system, the computing system may include where the conversation data includes one or more chat messages, one or more voice transcripts, and/or one or more emails.

In accordance with at least one aspect of the above computing system, the computing system may include where to provide the question-and-answer pair on the graphical user interface comprise to in response to determination that the knowledge base does not include any existing content similar to the question-and-answer pair, provide the question-and-answer pair and an option to create new content to add the question-and-answer pair to the knowledge base.

In accordance with at least one aspect of the above computing system, the computing system may include where to provide the question-and-answer pair on the graphical user interface comprises to, in response to determination that the knowledge base includes the existing content similar to the question-and-answer pair, provide the question-and-answer pair, a question or a title of the existing content, a first option to merge the question-and-answer pair with the existing content, and a second option to create new content to add the question-and-answer pair to the knowledge base.

In accordance with at least one aspect of the above computing system, the computing system may include where to provide the question answer pair on the graphical user interface includes to provide one or more alternative phrasings of the question selectable as alternative questions to the question of the question-and-answer pair.

In accordance with at least one aspect of the above computing system, the computing system may include where to extract a question-and-answer pair from the conversation data with the meta data using the machine learning model comprises to consolidate one or more question-and-answer pairs from the conversation data by grouping semantically similar questions among the one or more question-and-answer pairs.

In accordance with at least one aspect of the above computing system, the computing system may include where to determine whether the knowledge base includes any existing content similar to the question-and-answer pair comprises to compare the question of the question-answer-pair and existing content in the knowledge base to determine a similarity score between the question and the existing content, determine whether the similarity score exceed a predetermined threshold, and if the similarity score exceeds the predetermined threshold, determine that the knowledge base includes the existing content similar to the question-and-answer pair.

In accordance with at least one aspect of the above computing system, the computing system may include where the existing content is one or more existing articles and/or one or more existing frequently asked questions (FAQs) in the knowledge base, and the meta data includes a frequency of the question in the conversation data and one or more sources of the question within the conversation data where the question was extracted from.

In accordance with at least one aspect of the above computing system, the computing system may include where to update the knowledge base to integrate the question-and-answer pair in accordance with the input comprises to receive a modification to the question-and-answer pair to modify the question-and-answer pair, and update the knowledge base to integrate the modified question-and-answer with the knowledge base.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

That which is claimed:

1. A method for mining question-and-answer pairs from conversation data to update knowledge bases, the method comprising:
obtaining conversation data;
extracting a question-and-answer pair from the conversation data with meta data using a machine learning model, the question-and-answer pair including a question and an answer corresponding to the question;
determining whether a knowledge base includes any existing content similar to the question-and-answer pair;
providing the question-and-answer pair on a graphical user interface with an indication of a presence of any existing content in the knowledge base that is similar to the question-and-answer pair;
receiving an input to integrate the question-and-answer pair with the knowledge base; and
updating the knowledge base to integrate the question-and-answer pair in accordance with the input.

2. The method of claim 1, wherein the conversation data includes one or more chat messages, one or more voice transcripts, and/or one or more emails.

3. The method of claim 1, wherein providing the question-and-answer pair on the graphical user interface comprises:
in response to determining that the knowledge base does not include any existing content similar to the question-and-answer pair, providing the question-and-answer pair and an option to create new content to add the question-and-answer pair to the knowledge base.

4. The method of claim 1, wherein providing the question-and-answer pair on the graphical user interface comprises:
in response to determining that the knowledge base includes the existing content similar to the question-and-answer pair, providing the question-and-answer pair, a question or a title of the existing content, a first option to merge the question-and-answer pair with the existing content, and a second option to create new content to add the question-and-answer pair to the knowledge base.

5. The method of claim 1, wherein providing the question answer pair on the graphical user interface includes providing one or more alternative phrasings of the question selectable as alternative questions to the question of the question-and-answer pair.

6. The method of claim 1, wherein the input indicates how to integrate the question-and-answer pair with the knowledge base.

7. The method of claim 1, wherein extracting a question-and-answer pair from the conversation data with the meta data using the machine learning model comprises consolidating one or more question-and-answer pairs from the conversation data by grouping semantically similar questions among the one or more question-and-answer pairs.

8. The method of claim 1, wherein determining whether the knowledge base includes any existing content similar to the question-and-answer pair comprises:
comparing the question of the question-answer-pair and existing content in the knowledge base to determine a similarity score between the question and the existing content;
determining whether the similarity score exceed a predetermined threshold; and
if the similarity score exceeds the predetermined threshold, determining that the knowledge base includes the existing content similar to the question-and-answer pair.

9. The method of claim 1, wherein the existing content is one or more existing articles and/or one or more existing frequently asked questions (FAQs) in the knowledge base.

10. The method of claim 1, wherein the meta data includes a frequency of the question in the conversation data and one or more sources of the question within the conversation data where the question was extracted.

11. The method of claim 1, wherein updating the knowledge base to integrate the question-and-answer pair in accordance with the input comprises:
receiving a modification to the question-and-answer pair to modify the question-and-answer pair; and
updating the knowledge base to integrate the modified question-and-answer with the knowledge base.

12. A computing system for mining question-and-answer pairs from conversation data to update knowledge bases, the system comprising:
at least one processor; and
at least one memory comprising a plurality of instructions stored therein that, in response to execution by the at least one processor, causes the computing system to:
obtain conversation data;
extract a question-and-answer pair from the conversation data with meta data using a machine learning model, the question-and-answer pair including a question and an answer corresponding to the question;
determine whether a knowledge base includes existing content similar to the question-and-answer pair;
provide the question-and-answer pair on a graphical user interface with an indication of a presence of any existing content in the knowledge base that is similar to the question-and-answer pair;
receive an input to integrate the question-and-answer pair with the knowledge base; and
update the knowledge base to integrate the question-and-answer pair in accordance with the input.

13. The computing system of claim 12, wherein the conversation data includes one or more chat messages, one or more voice transcripts, and/or one or more emails.

14. The computing system of claim 12, wherein to provide the question-and-answer pair on the graphical user interface comprise to:
in response to determination that the knowledge base does not include any existing content similar to the question-and-answer pair, provide the question-and-answer pair and an option to create new content to add the question-and-answer pair to the knowledge base.

15. The computing system of claim 12, wherein to provide the question-and-answer pair on the graphical user interface comprises to:
in response to determination that the knowledge base includes the existing content similar to the question-and-answer pair, provide the question-and-answer pair, a question or a title of the existing content, a first option to merge the question-and-answer pair with the existing content, and a second option to create new content to add the question-and-answer pair to the knowledge base.

16. The computing system of claim 12, wherein to provide the question answer pair on the graphical user interface includes to provide one or more alternative phrasings of the question selectable as alternative questions to the question of the question-and-answer pair.

17. The computing system of claim 12, wherein to extract a question-and-answer pair from the conversation data with the meta data using the machine learning model comprises to consolidate one or more question-and-answer pairs from the conversation data by grouping semantically similar questions among the one or more question-and-answer pairs.

18. The computing system of claim 12, wherein to determine whether the knowledge base includes any existing content similar to the question-and-answer pair comprises to:
compare the question of the question-answer-pair and existing content in the knowledge base to determine a similarity score between the question and the existing content;
determine whether the similarity score exceed a predetermined threshold; and
if the similarity score exceeds the predetermined threshold, determine that the knowledge base includes the existing content similar to the question-and-answer pair.

19. The computing system of claim 12, wherein the existing content is one or more existing articles and/or one or more existing frequently asked questions (FAQs) in the knowledge base, and the meta data includes a frequency of the question in the conversation data and one or more sources of the question within the conversation data where the question was extracted from.

20. The computing system of claim 12, wherein to update the knowledge base to integrate the question-and-answer pair in accordance with the input comprises to:
receive a modification to the question-and-answer pair to modify the question-and-answer pair; and
update the knowledge base to integrate the modified question-and-answer with the knowledge base.
